(19) United States
(12) Patent Application Publication
(10) Pub. No.: US 2002/0086782 A1
(43) Pub. Date: Jul. 4, 2002

(54) Roller for guiding or treating, web-like materials, a method for manufacturing a casing for a roller, a casing for manufacturing such a roller, a method for exchanging the casing of such a roller, as well as the use of such a casing and the use of a material

(76) Inventors: Bruno Borger, Nesslau (CH); Roland Schanzer, Herisau (CH); Andreas Ruedi, Mannedorf (CH)

Correspondence Address: SHOEMAKER AND MATTARE, LTD., Crystal Plaza Building 1 - Suite 1203, 2001 Jefferson Davis Highway, Arlington, VA, 22202, US

(21) Appl. No.: 10/017,508

(22) Filed: Dec. 18, 2001

(30) Foreign Application Priority Data
Dec. 18, 2000 (EP) 00127488.5

(51) Int. Cl. B25F 5/02

(52) U.S. Cl. 492/56

(57) ABSTRACT

The invention relates to a roller (1) for guiding, in particular for pressing and/or for the pressure treatment of web-like materials, with a core (4) which carries an elastic casing (3), wherein the core (4) and the casing (3) are connected directly by a fastening layer (2) provided in an intermediate space between the core material and the casing material.

The invention relates to a roller for guiding, in particular for pressing web-like materials, a method for manufacturing such a roller, a casing for manufacturing such a roller, a method for changing the casing of such a roller, as well as the use of such a casing and the use of a material, according to the definition of the patent claims.

Known rollers for guiding or pressure treatment of web-like materials have an essentially cylindrical geometry. They consist in the inside of a carrying, hard core, of metal for example steel, and of an elastic casing of elastomers enclosing the core on a longitudinal side and rigidly connected to it. For example such rollers are used as bending impression cylinders for gravure printing systems where they ensure a uniform pressing onto a counter-roller.

The manufacture of such a roller is work-intensive, entails a multitude of technically complicated method steps, is inflexible and costly. The surface of the core is to be cleaned and provided with bonding agent before depositing the casing material. Furthermore thin elastomer layers are wound on, these elastomer layers are mechanically stabilised and by way of vulcanisation are connected into an elastic casing.

The document Dt-195 17 653 shows an improvement with respect to this, in which the construction of the elastomer layer winding as well as its vulcanisation into a casing and the mounting of the casing onto the core are separated. The casing is premanufactured as a sleeve and under pressure impingement is mounted onto the core provided with bonding agent. On account of the separation of the method steps a fully automatic manufacture of the casing is possible. Also the transport and storage of the rollers is simplified since only exchange casings need be delivered. Finally the mounting of the casing onto the core is effected rapidly.

The elastic casing in operation is subjected to high friction forces. Also in the casing there is effected much flexing work. By way of this the roller is heated to a considerable extent, and this heat must be led away via the core. On account of the different thermal expansion coefficients of the core and casing materials as well as a consequence of unbalanced masses caused by the flexing work, in the roller there occur large mechanical stresses. In particular large mechanical stresses occur at the connection between the core and the casing which weakens and loosens the connection between the casing and the core and leads to failures. A permanently stable, high-strength connection between the casing and the core is therefore desirable in order to reduce the failure rates of rollers during operation and to increase the life expectancy of the rollers.

A worn-down casing is renewed in that the casing is machined down by lathe. At the same time there often occurs damage to the core by way of the lathe tool which leads to failures. The core is thereupon cleaned and provided with bonding agent. Finally a new casing is mounted on. A simple, quick and secure method for the change of the casing is desirable in order to reduce the failure rates of cores when changing the casing and in order to change a casing more rapidly.

It is therefore the object of the invention to avoid the disadvantages of that which is known, in particular to provide rollers, methods and uses of the described manner in order to achieve a permanently stable and high-strength connection between the casing and the core. The invention is to provide a method for manufacturing such a roller, said roller being simply and inexpensively manufacturable. There is also to be provided a method for changing the casing with which the casing is exchangeable quickly, simply and securely. The roller, its manufacturing method and the method for changing the casing should in particular be compatible with tried and tested standards of the paper, printing, steel, textile as well as film/foil industries

This object is achieved by the invention according to the definition of the patent claims.

The invention improves in particular the connection of the casing and core of a roller. According to the state of the art the casing material by way of a layer is directly connected to the core material.

The invention is based on a reversal of the adhesing of the core and the casing by way of a layer bonding agent which is practised up to this day. In contrast to the state of the art a connection is effected by way of an intermediate fastening layer. Such a fastening layer is advantageously 0.5 to 15 mm thick, preferably 4 to 8 mm thick and consists of a liquid, cross-linking material, preferably of a two-component material. The core and casing material by way of this fastening layer are connected to one another and simultaneously separated from one another. By way of this a simple fastening of the casing on the core is made possible.

Thus the different material properties of the core and the casing on connection may be optimally adapted to one another via the fastening layer.

This above all concerns the moduli of elasticity. Often the core is of steel and the casing of an elastomeric material. Steel has a high modulus of elasticity of about 200,000 N/mm², whilst elastomers have a low modulus of elasticity of 15 to 250 N/mm². The difference of these moduli of elasticity is thus 3 factors of 10. Thus there may be selected a material for the fastening layer whose modulus of elasticity reduces from the core to the casing. Advantageously the fastening layer consists of epoxy resin with a modulus of elasticity of 800 to 1,000 N/mm², so that the difference of the moduli of elasticity is reduced by one factor of 10.

The manufacture of the roller is effected likewise with a reversal of the methods practised in the state of the art. The core and the casing are manufactured separately, wherein the core for example has the shape of a solid cylinder or of a tube, etc. and the casing the shape of a hollow cylinder. However in contrast to the state of the art, according to the method according to the invention the inner diameter of the casing is larger than the outer diameter of the core. Between the core and the casing there therefore lies an intermediate space. The casing is not drawn onto the core as with the state of the art, but the core and casing are connected to one another by a material filled or pressed into this intermediate space.

For this connection of core and casing the core distanced from the inner wall of the casing is centered in the hollow space of the casing. Advantageously the centering is effected via centering pieces.

The core and the casing have the same longitudinal axis, the core outer wall and the casing inner wall lie equidistant to one another. The thus formed intermediate space between the core and the casing is filled with a material. The material is e.g. a cross-linking plastic, preferably a two-component material. The material cures largely shrink-free in the intermediate space into a fastening layer and thus connects the core and the casing.

The core outer wall and the casing inner wall have a smooth surface. For supporting the connection of the core and the casing by way of a fastening layer the core outer wall may be roughened or provided with structurings, said roughenings or structurings permitting a positive fit engagement of the fastening layer with the core. In an analogous way and manner the casing inner wall may be roughened or provided with structurings, said roughenings or structurings permitting a positive-fit engagement of the fastening layer with the casing.

Likewise in a reversal to the state of the art there is effected the change of the casing. A worn-away casing until now has been changed such that the worn-away casing is machined down by lathe to the core, wherein often there is effected damage to the core by the lathe tool. The core is thereupon cleaned, provided with bonding agent and a new casing is mounted on.

In contrast to this with the method according to the invention for changing the casing a worn-away casing is not machined down by lathe to the core, but only to into fastening layer. On account of the thickness of the fastening layer damage to the core by the lathe tool is avoided. The fastening layer is at the same time at least partly reduced in thickness. Thereupon the core together with the thickness-reduced fastening layer is positioned in the hollow space of a new casing and the intermediate layer between the core or the thickness-reduced fastening layer and the casing is filled out with a material, said material hardening into a fastening layer. The advantages of the method according to the invention are evident, the method steps of the cleaning of the core as well as the application of a bonding agent are done away with.

The casing consists preferably of an elastomeric material such as for example acrylate rubber or acrylic ester rubber (ACM), acrylate-ethylene-polmethylene rubber (AEM), butadiene rubber or 1,4-polybutadiene (BR), epichlorohydrine rubber (ECO, CO), high-polymeric epichlorohydrine rubber (CHR), chlorobutyl rubber (CIIR), chloroprene rubber (CR), ethyl acrylate (EA), epoxy resin (EP), ethylene-propylene-dienpolymerisate (terpolymer) rubber (EPDM), polyurethane elastomer (EU), ethylene vinyl acetate co-polymer (EVAC), ethylene vinyl alcohol (EVOH), polypropylene tetraflourethylene copolymer (FPM), chlorosulphurised polyethylene (CSM), butyl rubber (IIR), isoprene rubber (IR), acrylnitril acrylate rubber (NBR), acrylnitril chloroprene rubber (NCR), natural rubber (NR), polyisobutylene (PIB), polytetraflourethylene (PTPE), polyurethane (PUR), polyvinyl acetate (PVAC), styrol butadiene rubber (SPR), silicon rubber (SIQ), unsaturated polyester resin (UP) as well as thermoplastic elastomers, duromers such as epoxide/phenol/formaldehyde/malamine poylester.

The casing in the known manner is manufactured in layers of elastomeric material. The elastomeric material is deposited onto a pin and vulcanised, For example for this winding techniques, extrusion techniques or moulding techniques are applied. For example foils or strips are injected or wound onto a pin. Tubings too may be deposited onto a pin.

Before depositing the casing onto the pin, at least one flexible separating layer, preferably a tissue, for example of polyamid fibres, which preferably forms a textile sheet formation, may be deposited onto the pin.

A first layer of elastomeric material is releasably attached on this separating layer. This first layer of elastomeric material is preferably 0.5 to 10 mm thick, preferred 2 to 3 mm thick and advantageously consists of ebonite, preferably of NR, BR, SBR, NBR, NCR and it has a 10 to 90%, preferably 20 to 80% sulphur part share.

If the separating layer, above all the tissue is removed, there remains an imprint with an increased roughness in the surface of the cylindrical opening of the casing. Furthermore the separating layer protects the surface of the casing in the region which is provided for connection to the core from contaminations. Instead of a tissue e.g. also a plastic foil with a rough surface may be deposited. Tissue imprints with roughnesses in the size order smaller/equal to 1 mm, preferably smaller/equal to 100 μm, preferably in the region of 12 μm to 25 μm have proven themselves particularly well in practise.

As a material for the fastening layer there is particularly suitable epoxy resin or epoxy resin combined with a cross-linking agent or epoxy adhesive. Advantageous is the use of epoxy resin combined with a cross-linking agent which at least partly contains modified polyamines such as polyamidsamine. Such a material cures into a connection layer with a particularly high temperature stability. The man skilled in the art with the knowledge of the present invention may realise many varied combinations of an epoxy resin with a cross-linking agent.

The material may be high-viscous or low-viscous. High-viscous materials may be pressed into the intermediate space between the core and the casing, low-viscous materials may be filled into this intermediate space. Particularly advantageous has shown to be the use of an epoxy resin combined with polyamidsamine. This low-viscous material according to DIN 53018 has at 25° C. a viscosity value of 8,000 MPa sec for the epoxy resin and a viscosity value of 300 MPa sec for polyamidsamine. With such viscosity values on filling the intermediate space between the core and the casing, surface unevennesses of the casing are filled out by the material. By way of this the surface of the connecting border layer is enlarged. Furthermore the cured border layer of the material engages into the surface irregularities of the casing. This leads to considerably improved loading capacity with torsion forces.

It is advantageous when the fastening layer in the temperature range of 200 to 100° C. has a thermal expansion coefficient of 0.2% to 2% preferably 0.5% to 0.9%.

It is also particularly advantageous when at the same time the modulus of elasticity is 800 to 1,000 N/mm², at least however is 30 N/mm².

In combination with steel cores such thermal expansion coefficients or moduli of elasticity lead to particularly resistant and permanently loadable roller designs.

The invention is suitable for the most varied of application fields. To the first extent the invention is suitable for manufacturing pressing rollers for printing machines. Such rollers are however also suitable for textile machines or paper machines and all types of installations in which web-like materials are guided. For example such rollers are use in the packaging industry for laminating, printing, coating and transporting packaging material and in the steel processing industry for coating, etching and as guide rollers. Above all the invention is particularly good with large pressing forces and corresponding roller loading, high rotational speeds and demanded service lives.

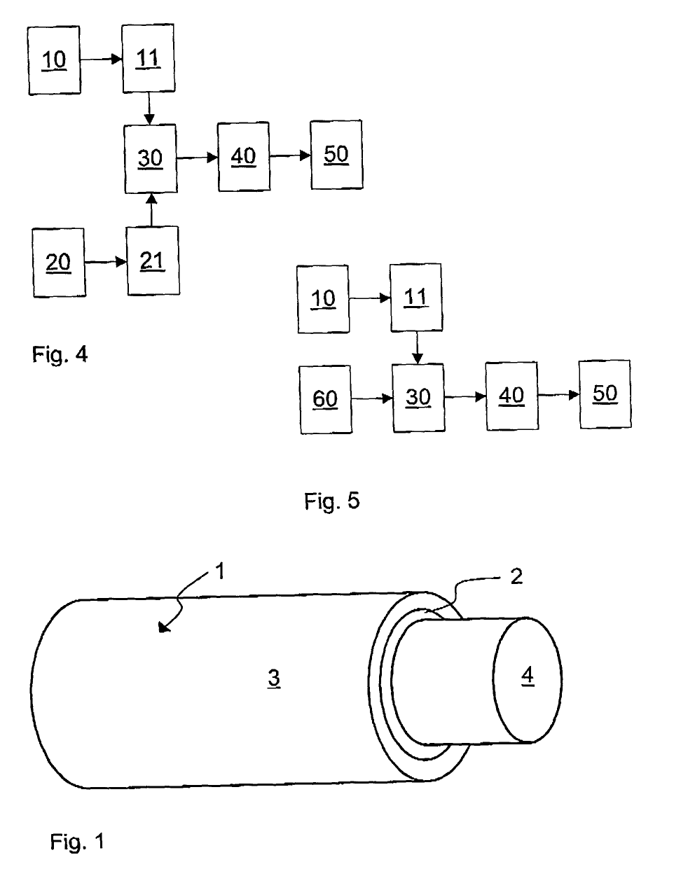

In the following the inventioned is explained in more detail in embodiment examples by way of the FIGS. 1 to 6. There are shown in:

FIG. 1 a schematic representation of a part of an embodiment form of a roller in a lateral view,

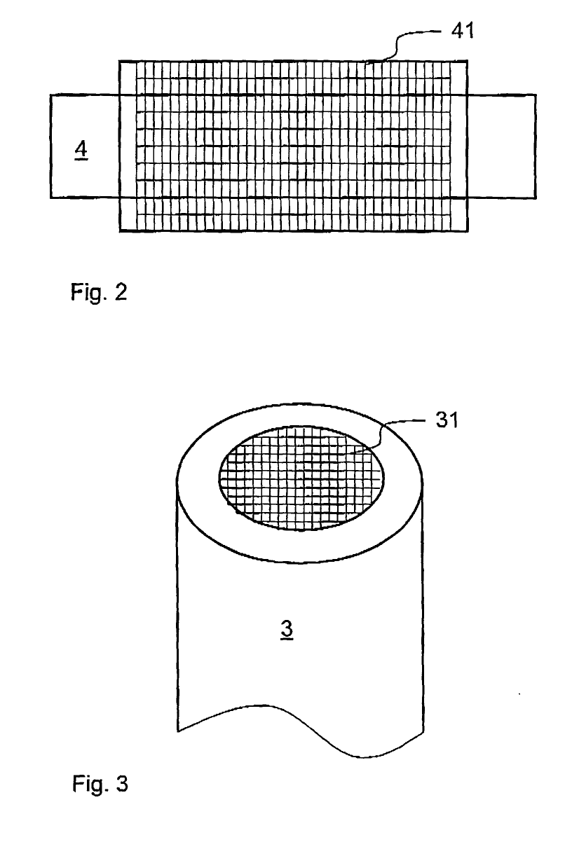

FIG. 2 a schematic representation of a part of an embodiment form of a core in a front view,

FIG. 3 a schematic representation of a part of an embodiment form of a casing in a lateral view,

FIG. 4 a schematic block diagram of the method steps with the manufacture of a roller,

FIG. 5 a schematic block diagram of the method steps on changing a casing and

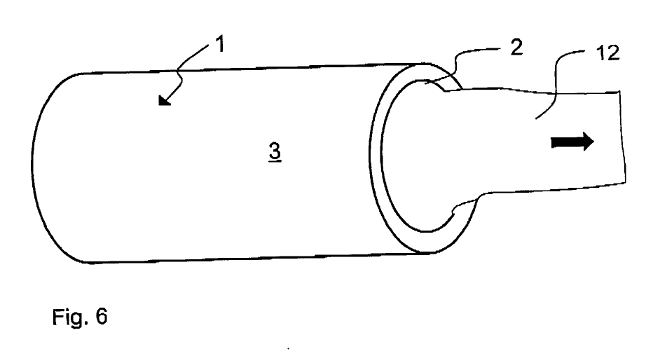

FIG. 6 the schematic representation of a casing with a separating layer.

FIG. 1 shows schematically a roller 1 for the pressure treatment of web-like materials with a core 4 which carries an elastic casing 3. The core 4 and the casing 3 are connected to one another by a fastening layer 2 separating the core and casing material.

One exemplary embodiment form of a cylindrical core 4 is shown in FIG. 2. Traditionally the core 4 consists of a hard material such as metal, for example of steel. It is however also possible to manufacture the core 4 out of other hard material such as fibre-re-inforced artifical resin. For example the document EP-0 385 948 discloses a core which consists of epoxy resin and reinforced carbon fibres. The core 4 may be a solid cylinder or a tube. Advantageously an outer wall of the core 4 is roughened or provided with structurings 41, said roughenings or structurings 41 permitting a positive-fit engagement of the fastening layer 2 with the core. The roughenings or structurings 41 lead to a surface area enlargement. The may cover the outer wall of the core 4 partially or over the whole circumference. In the exemplary embodiment form of a core 4 according to FIG. 2 the structurings 41 are fiberings consisting of carbon fibres running longitudinally and transversely to the longitudinal extension of the core 4. The man skilled in the art with the knowledge of the present invention may realise other structurings in the outer wall of a core, for example he may structure the outer wall of a core by incorporating grooves, webs or a rough thread.

An exemplary embodiment form of a hollow-cylindrical casing 3 is shown in FIG. 3. The casing 3 is preferably of an elastomeric material such as for example acrylate rubber or acrylic ester rubber (ACM), acrylate-ethylene-polmethylene rubber (AEM), butadiene rubber or 1,4-polybutadiene (BR), epichlorohydrine rubber (ECO, CO), high-polymeric epichlorohydrine rubber (CHR), chlorobutyl rubber (CIIR), chloroprene rubber (CR), ethyl acrylate (EA), epoxy resin (EP), ethylene-propylene-dienpolymerisate(terpolymer) rubber (EPDM), polyurethane elastomer (EU), ethylene vinyl acetate copolymer (EVAC), ethylene vinyl alcohol (EVOH), polypropylene tetraflourethylene copolymer (FPM), chlorosulphurised polyethylene (CSM), butyl rubber (IIR), isoprene rubber (TR), acrylnitril acrylate rubber (NBR), acrylnitril chloroprene rubber (NCR), natural rubber (YR), polyisobutylene (PIB), polytetraflourethylene (PTEE), polyurethane (PUR), polyvinyl acetate (PVAC), styrol butadiene rubber (SBR), silicon rubber (SIQ), unsaturated polyester resin (UP) as well as thermoplastic elastomers, duromers such as epoxide/phenol/formaldehyde/malamine poylester. Advantageously the inner wall of the casing is roughened or provided with structurings 31, said roughenings or structurings 31 permitting a positive-fit engagement of the fastening layer 2 with the casing 3. These roughenings or structurings 31 lead to an increase in the surface area. They may cover the inner wall of the casing 3 partially or over the whole circumference. In the exemplary embodiment form of a casing 3 according to FIG. 3 the structurings are imprints which derive from a separating layer according to FIG. 6. Such a separating layer 12 protecting the casing 3 on transport and storage from dirt and injuries consists advantageously of a tissue and preferably forms a textile sheet formation. The separating layer 12 is provided with longitudinal and transverse fibres, said longitudinal and transverse fibres on the inner wall producing imprints running longitudinally and transversely to the longitudinal extension of the casing 3. The man skilled in the art with the knowledge of the present invention may realise other structurings in the inner wall of a casing, for example he may roughen the inner wall of a casing with a brush and/or turn on a lathe structurings into the inner wall of a casing. Advantageously the casing is manufactured as is schematically shown in FIG. 6.

The casing 3 has an inner diameter which is larger than the outer diameter of the core 4. The core 4 may thus be centered into the hollow space of the casing 3. This intermediate space between the casing 3 and the core 4 is advantageously 0.5 to 15 mm thick, preferably 4 to 8 mm thick and separates the core and casing material from one another, so that these do not touch one another.

Advantageously with the depositing of the fastening layer onto the core for the first time, this core is priorly cleaned and provided with a bonding agent.

Then a cross-linking material is filled or pressed into the intermediate space between the core 4 and the casing 3. The material may be high-viscous or low-viscous. High-viscous materials may be pressed into the intermediate space between the core and the casing, low-viscous materials may be filled into this intermediate space. The material fills out the intermediate space without bubbles. At the same time the material is sufficiently flowable in order also to penetrate into the roughenings and structurings 31, 41. The use of an epoxy resin combined with polyamidsamine has proven to be successful. This has according to DIN 53018 at 25° C. a viscosity value of 8,000 MPa sec for the epoxy resin and a viscosity value of 300 MPa sec for polyamidsamine. The material cures in the intermediate space largely shrinkage-fee into the fastening layer 2 and thus connects the core 4 and the casing 3. The shrinkage value of the material in a temperature region of 20° C. to 100° C. is for example 0.2% to 2%, preferably 0.5% to 0.8%

The connection of the core 4 and the casing 3 may be optimally adapted to one another via the intermediate fastening layer 2.

In the schematic block diagram according to FIG. 4 there are shown by way of example the method steps with the manufacture of a roller 1. In a first method step 10 a casing 3 is manufactured, in a second method step 20 a core 4 is manufactured. In the method steps 11 and 21 the casing 3 and the core 4 are transported in a casing bearing and a core bearing respectively. In a third method step 30 the core 4 is centered in the casing 3. In a fourth method step 40 the thus formed intermediate space between the casing 3 and the core 4 is filled with a material. In a fifth method step 50 the material in the intermediate space cures largely shrinkage-fee into a fastening layer 2 connecting the casing 3 and the core 4.

In the first method step 10 the casing 3 is manufactured and in a further method step 11 is transported in a casing bearing. The manufacture of the casing is effected at a casing manufacturer in a method according to the state of the art. For example an elastomer layer winding is constructed and vulcanised into a casing 3. Apart from winding techniques however also extrusion or moulding techniques may be used. For example foils or tapes are injected or wound onto a pin. Tubings may also be deposited onto a pin. The casing 3 is thus premanufactured as a sleeve and packaged for transport. The storage of the casing 3 is effected at the manufacturer of the casing and/or the casing supplier and/or at the casing end-customer. With this the invention according to FIG. 6 as a preliminary stage with the casing manufacture envisages depositing a separating layer of a material with a rough surface. According to FIG. 6 with this there is incorporated at least one separating layer 12, preferably of a tissue, which forms a textile sheet formation. With this the cover layer 12 covers the casing 3 of elastomeric material to the inside and imprints the casing inner surface with the structure of the sheet formation. By way of this structure of the sheet formation the inner surface of the casing 3 is roughened in a controlled manner. Before depositing onto a core 4 the separating layer 12 is pulled out laterally. The casing 3 is then positioned with a clean, roughened inner surface onto the core 4 in the described manner.

In a similar way and manner one proceeds with the manufacture of the core 4. In the second method step 20 the core 4 is manufactured and in a further method step 21 is transported in a core bearing. The manufacture of the core 4 is effected at the core manufacturer and/or at the core supplier and/or at the core end-customer.

In the third method step 30 the core 4 is centered in the casing 3. The intermediate space between the casing 3 and the core 4 is advantageously 0.5 to 15 mm thick, preferably 4 to 8 mm thick and separates the core and the casing material from one another so that these do not touch one another. For centering, spacial distance retainers may be used as centering pieces.

In the fourth method step 40 a material is filled or pressed into the intermediate space between the core 4 and the casing 3. In a preferred variant the core 4 in the casing 2 is positioned standing mainly vertically in a manner such that the material alone under the effect of gravity flows into the intermediate space and completely fills out this without enclosing air bubbles. For this a lower opening of the intermediate space is closed with suitable positive-fit means, whilst the material is filled through an upper opening in the intermediate space. The material is sufficiently flowable in order also to penetrate into roughenings and structurings 31,41.

As a material for the fastening layer epoxy resin or epoxy resin combined with a cross-linking agent or epoxy adhesive are particularly suitable. Advantageous is the use of an epoxy resin combined with a cross linking agent which at least contains partly modified polyamines such as polyamidsamine. Such a material cures into a connection layer with a particularly high temperature stability. Advantageously the material is mixed directly before the filling with a hardener.

In the fifth method step 50 the material solidifies in the intermediate space largely shrinkage-free into the fastening layer 2 and thus connects the core 4 and the casing 3. The composition of material is selected such that it cures temper-free. With respect to this the use of an epoxy resin combined with a cross-linking agent which at least partly contains modified polyamines such as polyamidsamine is advantageous.

The third, fourth and fifth method step 30, 40, and 50 may be carried out at the roller manufacturer and/or at the casing or core manufacturer and/or at the casing or core supplier and/or at the end customer.

In the schematic block diagram according to FIG. 5 there are shown by way of example the method steps on changing an elastic casing 3 or a roller 1. The first, third to fifth method step 10, 20, 40, 50 correspond to those of the description of the manufacture of a roller according to FIG. 4, so that this is referred to and in the following only differences in the manufacture of a roller 1 are explained.

In contrast to the manufacture of a roller 1 on changing an elastic casing 3 of a roller 1 there occurs a sixth method step 60 with which a worn down casing 3 is machined down by lathe up to into the fastening layer 2. The fastening layer 2 must not be completely removed. By way of this a damage to the core 4 by way of the lathe tool is avoided. Advantageously the fastening layer is 0.5 to 15 mm thick, preferably 4 to 8 mm thick. The fastening layer 2 is at least partly reduced in its thickness. For example the fastening layer 2 is removed up to the half of its thickness. Thereupon the core 4 with this partly thickness-reduced fastening layer 2 is positioned in the hollow space of a new casing 3 and the intermediate space between the core 4 or the thickness-reduced fastening layer 2 and the casing 3 is filled with a material which cures into a new fastening layer 2.

1. A roller (1) for guiding or treating web-like materials, comprising a core which carries an elastic casing wherein the core and the casing are directly connected to one another by a fastening layer provided in an intermediate space between the core and the casing.

2. A roller according to claim 1, wherein said the fastening layer has a thickness of 0.5 to 15 mm thick, preferably 4 to 8 mm thick.

3. A roller according to claim 1, wherein the fastening layer consists of a cross-linking material.

4. A roller according to claim 1, wherein the core and the casing have different moduli of elasticity and wherein the fastening layer (2) has a modulus of elasticity of 800 to 1,000 N/mm², said modulus of elasticity of the fastening layer reducing the difference of the moduli of elasticity of the core and the casing.

5. A roller according to claim 1, wherein an outer wall of the core is roughened or provided with structurings wherein an inner wall of the casing is roughened or provided with structurings, said roughenings or structurings permitting a positive-fit engagement of the fastening layer with the core casing.

6. A roller according to claim 5, wherein the roughening is produced by the imprint of a separating layer.

7. A method for manufacturing an elastic casing for a roller for guiding or treating, comprising the steps of
providing a first layer of an elastomeric material
releasably attaching a separating layer below said first layer
forming a casing of elastic material on said first layer on a pin
optionally vulcanising said material.

8. A method for manufacturing an elastic material for a roller according to claim 7, wherein an imprint of the surface of the separating layer is formed in said casing said imprint corresponding to the desired surface structure or roughness of the casing surface.

9. A method for manufacturing an elastic casing for a roller according to claim 7, wherein a separating layer of a textile sheet formation is applied.

10. A method for manufacturing an elastic casing for a roller according to claim 7, wherein the first layer is made of an elastomeric material 0.5 to 10 mm thick, said material consisting of ebonite, preferred of NR, BR, SBR, NBR, NCR and wherein it has a sulphur part share of 10 to 90%.

11. An elastic casing manufactured in a method according to claim 7.

12. A method for manufacturing a roller (1) for guiding or treating web-like materials, comprising the steps of
providing a core such as a metal core
in a separate working step providing an elastic casing having an inner diameter larger than the outer diameter of the core
centering the core in said casing relative to the longitudinal axis of said casing thereby forming an intermediate space between the core and the casing
filling said space with a liquid curable in particular crosslinking material
curing said material thereby producing a fastening connecting the core and the casing.

13. A method for manufacturing a roller according to claim 12, wherein the material in the intermediate space is cured in a shrink-free as well as a substantially temper-free manner.

14. A method for manufacturing a roller according to claim 12, comprising the steps of roughening or structuring an outer wall of the core or an inner wall of the casing.

15. A method for manufacturing a roller according claim 12, wherein an elastic casing (3) according to claim 11 is provided.

16. A method for manufacturing a roller according to claim 15, wherein the separating layer is removed before positioning the casing on the core.

17. A method for exchanging an elastic casing of a roller, with a core which carries said casing, comprising the steps of removing the casing off up to into a fastening layer between the core and the casing thereby reducing the fastening layer at least partly in thickness,
centering a new casing on the core above the fastening layer reduced in thickness,
filling a remaining intermediate space between the fastening layer reduced in thickness and the casing with a liquid, curing, in particular cross-linking material, said material in the intermediate space curing largely shrinkage-free thereby connecting to the partly removed-off fastening layer.

18. The use of a material consisting of epoxy resin or of epoxy resin in combination with a cross-linking agent or of an epoxy adhesive for the direct connection of an elastic casing to a core of a roller for guiding or treating, of web-like materials and for producing a fastening layer in an intermediate space between the casing (3) and the core (4).

19. The use of a material according to claim 18, wherein the cross-linking agent at least partly contains modified polyamines such as polyamidsamine.

20. The use of a material acording to claim 18, wherein the epoxy resin according to DIN 53018 at 25° C. has a viscosity value of 8,000 MPa sec and that the cross-linking agent has a viscosity value of 300 MPa sec.

21. The use of an elastic casing for a roller for guiding or treating a web-like materials, said roller having a core, which carries the casing, wherein the casing (3) has a surface roughness of smaller than/equal to 1 mm, preferably smaller than/equal to 100 μm, preferably in the region of 12 μm to 25 μm, in the region of an intermediate space between the core (4) and the casing (3).
